(19) United States
(12) Patent Application Publication
(10) Pub. No.: US 2009/0181182 A1
(43) Pub. Date: Jul. 16, 2009

(54) MULTIPURPOSE DIGITAL INK

(76) Inventor: Donald D. Sloan, Platte City, MO (US)

Correspondence Address: HOVEY WILLIAMS LLP, 10801 Mastin Blvd., Suite 1000, Overland Park, KS, 66210, US

(21) Appl. No.: 11/972,574

(22) Filed: Jan. 10, 2008

(51) Int. Cl. C08F 2/48; C08L 31/02; B05D 5/00

(52) U.S. Cl. 427/508; 525/308; 524/533; 427/256

(57) ABSTRACT

Multipurpose digital inks and methods of printing images onto substrates using such inks are provided. Generally, the digital inks are UV-curable and comprise a multifunctional acrylate monomer, a monofunctional acrylate monomer, a polymer resin, and an oligomer. The inks may be used to digitally print images using an inkjet printer onto a variety of substrates, particularly those made from synthetic resin materials.

### BACKGROUND OF THE INVENTION

1. Field of the Invention

The present invention is generally directed toward ink formulations to be used with inkjet printers. The ink formulations are particularly suited for application to synthetic resin substrates, and when cured, exhibit excellent water and chemical resistance properties.

2. Description of the Prior Art

Inkjet imaging techniques have become very popular in commercial and consumer applications. Inkjet printers typically operate by injecting ink onto a receiving substrate in controlled patterns of closely spaced ink droplets. By selectively regulating the pattern of ink droplets, inkjet printers can produce a wide variety of printed features including text, graphics, images, holograms, and the like.

Thermal inkjet printers and piezo inkjet printers are two of the most common types of inkjet systems in widespread use. For both approaches, inks must meet stringent performance requirements in order for the inks to be appropriately jettable and for the resultant printed features to have the desired mechanical, chemical, visual, and durability characteristics. The most traditional types of inks are those which are solvent or water based. However, these types of inks present certain drawbacks.

Solvent-based inks, while being readily jettable, may not be compatible with certain types of synthetic resin substrates. The solvent in the ink may attack and degrade the substrate being printed upon thus producing a product of poor quality. Water-based inks, while more compatible with such substrates, tend to cure much more slowly than their solvent-based counterparts.

Inks are being developed which do not require the evaporation of a solvent in order to cure. Such inks are generally referred to as UV-curable inks and comprise various monomers and resins that polymerize and cross-link upon exposure to UV radiation. However, the mechanical and chemical characteristics of these inks are not highly predictable. Thus, certain inks which adhere well to some substrates do not necessarily adhere well to others.

Therefore, there is a need in the art for multipurpose digital inks that are compatible with a broad range of substrates and exhibit excellent chemical and water resistance characteristics.

### SUMMARY OF THE INVENTION

The present invention overcomes the above problems by providing multipurpose digital inks and methods of printing images on substrates using the inks. The printed images exhibit strong adhesion to the substrate and are highly resistant to peeling, cracking, or otherwise separating from the substrate even when exposed to extreme conditions. In one embodiment of the present invention, there is provided a digital ink comprising a multifunctional acrylate monomer, a monofunctional acrylate monomer, a polymer resin, and an oligomer.

In another embodiment of the present invention, there is provided a method of printing an image onto a substrate comprising providing a substrate comprising a synthetic resin material, and printing the image on the substrate using an inkjet printer and a digital ink. The digital ink comprises a multifunctional acrylate monomer, a monofunctional acrylate monomer, a polymer resin, and an oligomer.

### BRIEF DESCRIPTION OF THE DRAWINGS

FIG. 1 is a perspective view of an array of inkjet heads that can be used in conjunction with the present invention;

FIG. 2 is a is a cross-sectional view of a single inkjet head showing an ink/catalyst dispersal pattern wherein the ink and catalyst combine before contacting the substrate.

FIG. 3 is a is a cross-sectional view of a single inkjet head showing an ink/catalyst dispersal pattern wherein the ink and catalyst combine subsequent to the ink contacting the substrate; and

FIG. 4 is a is a cross-sectional view of a single inkjet head showing an ink/catalyst dispersal pattern wherein the ink and catalyst are both sprayed onto the substrate.

### DETAILED DESCRIPTION OF THE PREFERRED EMBODIMENT

Generally, the ink formulations made in accordance with the present invention are multipurpose inks that are suitable for use in a wide variety of applications. The inks are lightfast, exhibit excellent durability, and chemical and water resistance thereby making them especially suitable for the printing of banners, fleet marks, or any other materials which may be exposed to the elements.

In one embodiment, the multipurpose ink formulations comprise a multifunctional acrylate monomer, a monofunctional acrylate monomer, a polymer resin, and an oligomer. As used herein, the term “multifunctional monomer” refers to a monomer having more than one polymerizable functional group (i.e., polymerizable, for example, through a free radical polymerization reaction). For example, difunctional and trifunctional monomers are types of multifunctional monomers that may be used with the present invention. Multifunctional monomers used with the present invention generally exhibit molecular weights of between about 100 to about 600 g/mole, and especially between about 150 to about 400 g/mole.

The term “monofunctional monomer” refers to a monomer having only one polymerizable functional group. It is understood, though, that the monomers may include moieties which are capable of cross-linking with moieties of other monomers, oligomers, or resins. The presence of these cross-linkable moieties does not change the monomer's status as either monofunctional or multifunctional. Generally, monofunctional monomers used with the present invention exhibit molecular weights of between about 100 to about 600 g/mole, and especially between about 150 to about 400 g/mole.

As used herein, the term “polymer resin” refers to a polymer or copolymer that comprises substantially no further functional groups capable of free radical polymerization. However, the resin may include moieties that are capable of cross-linking with other resins, monomers, or oligomers. Generally, the polymer resins used with the present invention exhibit molecular weights of between about 2,500 to about 25,000 g/mole, more particularly between about 4,000 to about 15,000 g/mole.

As used herein, the term “oligomer” refers to two or more reacted monomers or monomeric chains that include functional groups that are capable of further polymerization. Generally, the oligomers used with the present invention exhibit molecular weights of at least about 10,000 g/mole, and more particularly between about 10,000 to about 70,000 g/mole.

In certain embodiments, the ink formulations comprise between about 20 to about 60% by weight of at least one multifunctional acrylate monomer. Preferably, the formulations comprise between about 25 to about 50% by weight of the multifunctional monomer, and more preferably between about 30 to about 45% by weight. Exemplary multifunctional acrylate monomers include those selected from the group consisting of 1,6-hexanediol dimethacrylate, neopentyl glycol diacrylate, tripropylene glycol diacrylate, ethoxylated trimethylolpropane triacrylate, trimethylolpropane triacrylate, 2-(2-ethoxyethoxy) ethyl acrylate, and combinations thereof.

The ink formulations also comprise between about 1 to about 20% by weight of at least one monofunctional acrylate monomer. Preferably, the ink formulations comprise between about 3 to about 15% by weight of the monofunctional monomer, and more preferably between about 5 to about 12% by weight. Exemplary monofunctional acrylate monomers include those selected from the group consisting of monofunctional acrylate monomer being selected from the group consisting of methyl (meth)acrylate, ethyl (meth)acrylate, butyl (meth)acrylate, 2-phenoxyethyl acrylate, isobornyl acrylate, and combinations thereof. The expression “(meth)acrylate” used herein denotes either the acrylate or methacrylate.

At least one polymer resin is generally present in the ink formulations at a level of between about 1 to about 15% by weight, preferably between about 2 to about 12% by weight, and more preferably between about 5 to about 10% by weight. In certain embodiments, the polymer resin presents an acrylic backbone. Exemplary acrylic polymers or copolymers for use with the ink compositions of the invention include polyethyl(meth)acrylate, polymethyl (meth)acrylate, polybutyl (meth)acrylate, or copolymers thereof in any combination. Commercial polymers or copolymers for use with the invention include those obtained from Dianal America, Inc. of Pasadena, Tex., under the designations MB-7022 (acid #0), MB-2588 (acid #15), BR-115 (acid #0), MB-2543 (acid #3), BR-220 (acid #9), MB-2823 (acid #0), MB-2494 (acid #6), and MB-2594. Another exemplary acrylic polymer for use in the ink composition of the present invention is a low viscosity aromatic monoacrylate sold under the designation CN 131 by Sartomer Company, Inc, Exton, Pa.

At least one oligomer is generally present in the ink formulations at a level of between about 10 to about 30% by weight, preferably between about 12 to about 25% by weight, and more preferably between about 15 to about 23% by weight. Exemplary oligomers that may be used with the present invention include polyurethanes, acrylic materials, polyesters, polyimides, polyamides, epoxies, polystyrene, styrene, and substituted styrene containing materials, silicone containing materials, fluorinated materials, and combinations thereof. However, acrylic materials are particularly preferred. An exemplary commercial oligomer that may be used with the present invention is VIAJET 400 available from Cytec Industries, Smyrna, Ga.

The ink formulations may include additional components such as those selected from the group consisting of initiators, a wetting agents, rheology modifiers, stabilizers, and pigments. The pigment used in the present invention may be supplied in granular or liquid form or as solids dispersed in a liquid carrier. As used herein, the term “pigment” refers to an insoluble colorant or solid colorant particles that remain suspended or dispersed when introduced into a carrier fluid. Furthermore, it is to be understood that the term “pigment” is not meant to encompass a dye or water-soluble colorant containing particles that are fully dissolved in the carrier fluid.

The pigment preferably presents particle sizes of less than about 1 micron, thus enabling the particles to be jetted from an inkjet head without clogging the nozzles. Generally, the pigment is present in the ink formulations at a level of between about 3 to about 40% by weight depending upon the pigment color. In certain embodiments, the pigment is present at a level of between about 5 to about 20% by weight.

The ink formulations made according to the present invention generally present viscosities of between about 2 to about 50 cp at 35° C., more specifically between about 5 to about 30 cp at 35° C., and especially between about 10 to about 20 cp at 35° C. The low ink viscosities permit the ink to be jetted through small diameter piezoelectric inkjet heads having nozzle diameters of between about 20 to about 60 microns. The inks can be used in conjunction with heated inkjet heads which serve to lower the viscosity even further. The heated inkjet heads can heat the ink to temperatures of between about 25° C. to about 90° C., however, preferably, the ink will be heated to between about 30° C. to about 50° C. Upon heating, the viscosity of the ink is reduced, preferably to a level of about 8 to about 22 centipoise at 40° C. Another advantage of low viscosity is that smaller ink drop sizes are possible than with other kinds of inks. Preferably, the drop size of the inks of the present invention are between about 30 to about 140 picoliters, more preferably between about 30 to about 80 picoliters.

The inventive ink formulations are generally UV-curable and do not contain any separately added water or solvent. By “separately added,” it is meant a material that is separate from an explicitly recited component of the ink composition and added to the formulation by itself and not as a mixture of other non-solvent components. Even though an explicitly recited component may exhibit the ability to dissolve or partially dissolve one or more of the other recited components, it is not a “separately added solvent” for purposes herein. The present invention does not require a solvent for the purposes of reducing the overall surface tension of the composition, reducing the viscosity of the composition, or promoting the desired level of wetting or adhesion of the ink to the substrate. Thus, the present invention has eliminated the need for and, in certain embodiments, does not in fact include a solvent such as those described in U.S. Pat. No. 6,558,753, incorporated by reference herein. In particularly preferred embodiments, the ink composition comprises less than about 0.05% by weight of a separately added solvent, more preferably less than about 0.001% by weight, and most preferably is entirely free of a separately added solvent. In addition, ink formulations made in accordance with the present invention do not contain a plasticizer. Thus, the problems of rewetting are avoided using the present ink formulations as there is no plasticizer to migrate from the ink after it has been applied to a substrate.

The multipurpose ink formulations are generally prepared by first synthesizing a varnish formulation. The varnish formulation is then combined with additional components to form the final ink composition. The varnish formulation generally comprises a multifunctional monomer, a monofunctional monomer and a polymer resin. In certain embodiments, these components are present in similar amounts, such as between about 25 to about 40% by weight, particularly between about 28 to about 38% by weight. In addition, the varnish may also contain a stabilizer such as Z-4500 ST-1 FIRST CURE polymerization inhibitor available from Eliokem of France. The stabilizer may be present at a level of between about 0.5 to about 3% by weight.

The ink formulations are then prepared using the varnish and other components including an oligomer, an initiator, a pigment, a wetting agent, a flow modifier, and further amounts of a multifunctional monomer. The initiator may generally comprise a solution of photo-initiator compounds. As used herein, the term “photo-initiator” refers to a compound that absorbs light energy and is responsible for the production of free radicals in a free radical polymerization system. UV curable photo-initiators generally cure between the spectral output range of about 260 to about 320 nanometers. The LED curable photo-initiators generally cure between the spectral output range of about 250 to about 410 nanometers. Exemplary photo-initiators suitable for use with the present invention include ITX (2-isopropylthiaoxanthone), Irgacure® 184 (1-benzoyl-1-hydroxycyclohexane), TPO (2,4,6-trimethylbenzoylphenylphosphine oxide), benzoin ethers such as benzoin isopropyl ether, benzyl dimethyl ketal (commercially available as Irgacure® 651 from Ciba-Geigy), 2-methyl-1-[4-(methylthio)phenyl]-2-(4-morpholinyl)-1-propanone (Irgacure® 907), 2-benzyl-2-(dimethylamino)-1-[4-(4-morpholinyl)phenyl]-1-butanone (Irgacure® 369), mono- and bis-acylphosphines such as Irgacure® 1700, Irgacure® 1800, Irgacure® 1850, Irgacure® 184, Darocur® 4265, and Darocur® 1173. Typically, the initiator solution is present within the ink formulation at a level of between about 10 to about 20% by weight.

The ink formulations may be applied to any type of substrate using an inkjet printer. Substrates to which the ink bonds particularly well include synthetic resin materials selected from the group consisting of polyvinyls, polyurethanes, polyolefins, polybutadienes, and combinations thereof. Exemplary substrates include pliable synthetic resin films especially those polyolefins selected from the group consisting of linear low-density polyethylene, high-density polyethylene, low-density polyethylene, polypropylene, ethylene-propylene-(diene) copolymers and terpolymers, and combinations thereof, and polyvinyls such as polyvinyl chloride. In certain embodiments, the substrate is particularly well suited for forming banners and fleet marks.

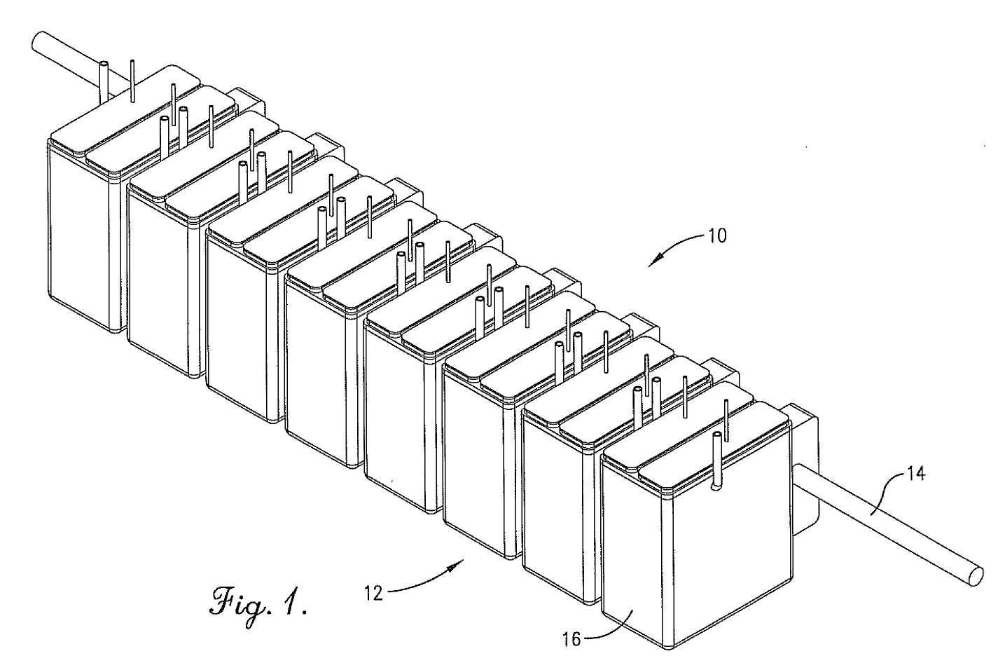

The ink may be applied to the substrate using any appropriate inkjet printer. In one embodiment, the ink formulations are dispensed from a multiple head inkjet system 10 as shown in FIG. 1. Other embodiments of system 10 are described in co-pending U.S. patent application Ser. No. 11/557,750, incorporated by reference herein. System 10 is capable of applying a plurality of different inks to a substrate along with a catalyst for initiating and/or accelerating the curing of the ink. The catalyst is separately discharged from the inkjet head and combined with the ink prior or subsequent to contacting the substrate. Thus, system 10 allows for the use of curing agents in order to speed the ink curing process without risking premature curing of the ink within the inkjet head.

System 10 comprises an array of inkjet heads 12 attached to a rod bearing 14 as may be the case inside an inkjet printer. Of course, any other similar “track” structure suitable to support array 12 may be employed in place of bearing 14. Array 12 comprises a plurality of inkjet heads 16, each of which includes at least one digital ink and at least one catalyst therein. As shown, array 12 includes eight separate heads 16. However, it is understood that array 12 could include fewer or more heads depending upon the particular printer or printing application being performed. Thus, the present invention may be used with as few as one inkjet head up to 16, 24, or more heads as necessary or desired.

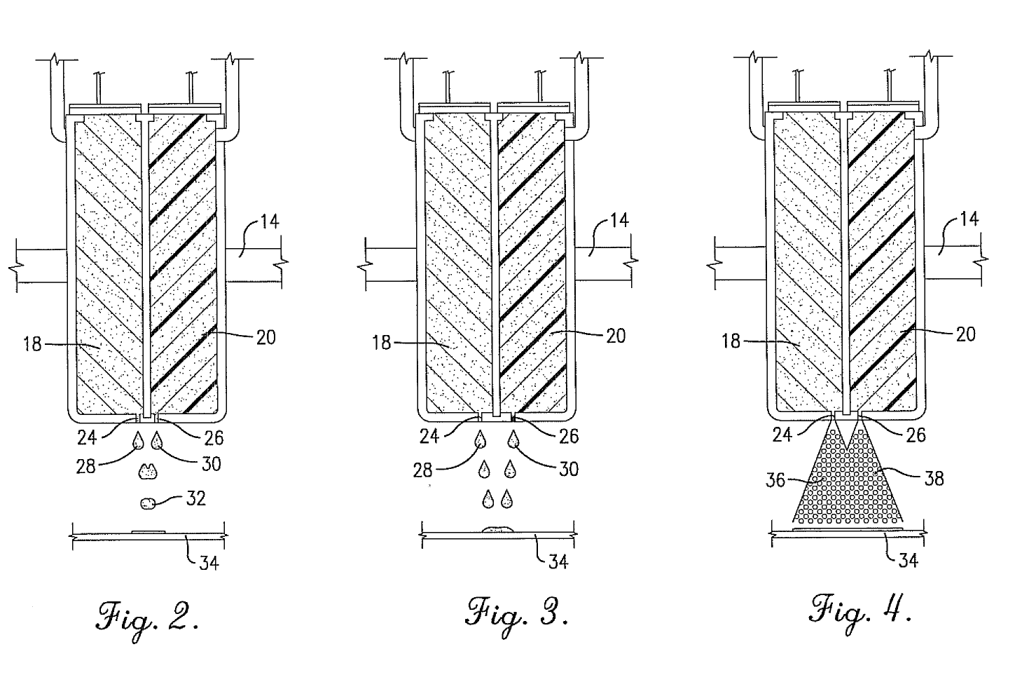

FIG. 2 depicts an exemplary inkjet head 16 that comprises an ink chamber 18 and a catalyst chamber 20 that are separated by a partition 22. Head 16 may contain a plurality of separate chambers therein, however, for ease of illustration head 16 as shown contains only two separate chambers. It is within the scope of the present invention to use an inkjet head that comprises two, four, six, eight, or more individual chambers. Head 16 presents at least one ink nozzle 24 and at least one catalyst nozzle 26 in communication with respective chambers 18 and 20. It is preferable that head 16 presents a plurality of nozzles 24 and 26 that are axially aligned into respective columns of nozzles. While not as preferred as the configurations described above, array 12 can comprise a plurality of heads that are capable of only dispensing one type of material. In such an arrangement, heads 16 should be spaced together as closely as possible so that the ink and catalyst nozzles may be in close proximity to each other.

Inkjet head 16 can operate according to any known inkjet technology, however, it is preferred that head 16 be a high-resolution piezoelectric printhead. Exemplary printheads include the SPECTRA SL-128, SPECTRA NOVA PH 256, and EPSON Series 10000 printheads.

Nozzles 24 and 26 can be configured to produce different droplet or spray patterns. In FIG. 2, nozzles 24 and 26 are configured to provide converging ink and catalyst droplets 28, 30 which combine to form a merged droplet 32 prior to contacting substrate 34. By combining ink and catalysts droplets 28, 30 prior to contact with substrate 34, curing of the digital ink can occur as quickly as possible.

FIG. 3 depicts another nozzle configuration. Nozzles 24 and 26 still provide converging ink and catalyst droplets 30, 32 however, these droplets do not combine until at least the ink droplet has contacted substrate 34. Thus, mixing of the ink and catalyst occurs on substrate 34 as opposed to that which is shown and described in FIG. 2.

FIG. 4 shows yet another type of nozzle configuration wherein nozzles 26 and 28 produce overlapping spray patterns 36, 3 8 of ink and catalyst, respectively. This dispersal pattern is similar in function to that shown in FIG. 2 inasmuch as the ink and catalyst are combining prior to contact with substrate 34. The spray configuration of FIG. 4 may be modified so that ink 36 may be deposited onto substrate 34 prior to application of catalyst 38. Controlled firing of nozzles 26 and 28 as head 16 traverses bearing 14 would facilitate such an arrangement.

Generally, the catalyst used with the present invention initiates and/or accelerates the formation of free radicals in the resin portion of the ink which causes the ink to cross-link thereby producing a more durable printed image. Selection of a catalyst depends at least in part on compatibility with the ink system and the conditions under which curing is desirable.

There are two basic types of catalysts that can be used. One type of catalyst initiates curing of the ink under ambient conditions without further energy input. This type of catalyst is also referred to as a self-initiating catalyst. Cross-linking of the ink resin begins upon contact with the catalyst. Exemplary self-initiating catalysts include isocyanate prepolymers, zinc oxide, magnesium oxide, zinc ammonium complex, zirconium ammonium complex, zinc acetate, and zirconium acetate. A particularly preferred catalyst is an aqueous alkaline solution of stabilized ammonium zirconium carbonate, containing anionic hydroxylated zirconium polymers available from MEL Chemicals, Flemington, N.J., under the name BACOTE 20. BACOTE 20 presents a viscosity of about 5 cp, a pH of 9.2-9.8, a specific gravity of 1.36, and is stable for extended periods of time at elevated temperature. It is important that these catalysts be kept separate from the inks until each is discharged from the printer head, as curing begins immediately upon contact.

Another type of catalyst is one that requires additional energy input in order to initiate and/or speed the curing process. Generally, the additional energy input is provided as thermal or heat energy thereby making this ink and catalyst system a thermally reactive system. Exemplary catalysts of this type include urea formaldehyde resins, melamine formaldehyde resins, aziridine resins, and carbodiimide resins. The thermal energy may be supplied to the ink/catalyst system through a low-temperature bake cycle in which the substrate having the ink printed thereon is passed through an oven or a tunnel dryer. The bake cycle is generally carried out at a temperature between about 185-350° F. (85-177° C.) and may last for a period of seconds to minutes, preferably between about 3-8 minutes. Also, at least some of the thermal energy may be supplied to the ink and catalyst individually prior to jetting through the use of a heated inkjet head.

The ratio of ink to catalyst can be varied depending upon the curing properties desired. Particularly, the amount of catalyst delivered through the inkjet head is based upon the solids content of the ink. The catalyst is generally provided to the inkjet head as an aqueous dispersion or solution that can be diluted as needed. The catalyst is present in this dispersion or solution at a level of about 0.1-50% by weight, more preferably between about 0.25-10% by weight, and most preferably between about 0.25-6% by weight.

An accelerator may be used in addition to the catalyst for accelerating curing of the ink on the substrate. Preferably, the accelerator is an acid catalyst such as p-toluene sulfonic acid (PTSA). The accelerator may be present in the system at a level of about 0.01-5% based on the combined weight of the ink and catalyst system, more preferably between about 0.25-2%, and most preferably between about 0.5-1%. Preferably, the accelerator is initially part of the catalyst formulation that is discharged from the inkjet head. However, it is within the scope of the present invention for the ink formulation to include the accelerator. Care should be taken when selecting an accelerator to be added to the ink formulation so that the ink does not gel inside the inkjet head.

After printing, the substrate may be exposed to UV or LED light in order to initiate and/or accelerate curing of the ink. Generally, during the curing process, the monomers and/or oligomers undergo free-radical polymerization and cross-link with each other and/or the polymer resin. Additionally, the ink chemically binds with the substrate in order to produce a highly durable image that exhibits superior chemical and water resistance. The substrate having the image printed thereon can be immersed in water for 48 hours, and up to 96 hours, and the image will show no visible signs of peeling, cracking, or otherwise separating from the substrate, Further, the image printed on the substrate is capable of withstanding extreme temperature conditions, such as being exposed to a temperature of −10° C. for 1 hour, and will show no visible signs of peeling, cracking, or otherwise separating from the substrate upon flexing of the substrate (especially folding of the substrate back on top of itself). Such properties are particularly important for outdoor banners which can be exposed to a broad range of temperature extremes.

### EXAMPLES

The following examples set forth ink formulations in accordance with the present invention. It is to be understood, however, that these examples are provided by way of illustration and nothing therein should be taken as a limitation upon the overall scope of the invention.

### Example 1

The following is an exemplary varnish formulation that is used in forming various inks in accordance with the invention.

| Acrylic Varnish | Amount (weight %) |
|---|---|
| 1,6 Hexanediol Dimethacrylate | 34.33 |
| Isobornyl Acrylate | 34.32 |
| ST-1 Stabilizer | 1.35 |

(Add while mixing)

| | |
|---|---|
| MB-2594 Acrylic Resin | 30 |

### Example 2

The following is an exemplary photo-initiator solution that may be used in the inks according to the present invention.

| Letdown Photo-initiator Solution | Amount (weight %) |
|---|---|
| 1173 Darocure ® | 27 |
| ST-1 Stabilizer | 1 |

(Add while mixing)

| | |
|---|---|
| DETX (photo-initiator) | 18 |
| Irgacure ® 369/aminoketone | 18 |
| Irgacure ® 184/Alpha-hydroxy ketone | 18 |
| Ethyl-4 (dimethylamino) Benzoate | 18 |

### Example 3

The following is an exemplary yellow ink made in accordance with the present invention.

| Component | Amount (weight %) |
|---|---|
| Acrylic Varnish | 15 |
| VIAJET 400 | 18 |
| Initiator Solution | 14 |
| Yellow Pigment | 14 |
| DOD (Wetting Agent) | 2 |
| 1,6 Hexanediol Dimethacrylate | 36.5 |
| TEGO 450 (Flow Modifier) | 0.5 |

### Example 4

The following is an exemplary magenta ink made in accordance with the present invention.

| Component | Amount (weight %) |
|---|---|
| Acrylic Varnish | 18 |
| VIAJET 400 | 18 |
| Initiator Solution | 17 |
| Magenta Pigment | 14 |
| DOD (Wetting Agent) | 2 |
| 1,6 Hexanediol Dimethacrylate | 30.75 |
| TEGO 450 (Flow Modifier) | 0.25 |

### Example 5

The following is an exemplary cyan ink made in accordance with the present invention.

| Component | Amount (weight %) |
|---|---|
| Acrylic Varnish | 18 |
| VIAJET 400 | 20 |
| Initiator Solution | 15 |
| Cyan Pigment | 7 |
| DOD (Wetting Agent) | 3 |
| 1,6 Hexanediol Dimethacrylate | 36.5 |
| TEGO 450 (Flow Modifier) | 0.5 |

### Example 6

The following is an exemplary light magenta ink made in accordance with the present invention.

| Component | Amount (weight %) |
|---|---|
| Acrylic Varnish | 18 |
| VIAJET 400 | 20 |
| Initiator Solution | 16 |
| Magenta Pigment | 7 |
| DOD (Wetting Agent) | 3 |
| 1,6 Hexanediol Dimethacrylate | 35.5 |
| TEGO 450 (Flow Modifier) | 0.5 |

### Example 7

The following is an exemplary light cyan ink made in accordance with the present invention.

| Component | Amount (weight %) |
|---|---|
| Acrylic Varnish | 18 |
| VIAJET 400 | 20 |
| Initiator Solution | 15 |
| Cyan Pigment | 4.5 |
| DOD (Wetting Agent) | 3 |
| 1,6 Hexanediol Dimethacrylate | 39 |
| TEGO 450 (Flow Modifier) | 0.5 |

### Example 8

The following is an exemplary black ink made in accordance with the present invention.

| Component | Amount (weight %) |
|---|---|
| Acrylic Varnish | 18 |
| VIAJET 400 | 20 |
| Initiator Solution | 15 |
| Black Pigment | 4.5 |
| DOD (Wetting Agent) | 3 |
| 1,6 Hexanediol Dimethacrylate | 35 |
| TEGO 450 (Flow Modifier) | 0.5 |
| CI 250 | 4 |

I claim:

1. A digital ink comprising:
a multifunctional acrylate monomer;
a monofunctional acrylate monomer;
a polymer resin; and
an oligomer.

2. The digital ink according to claim 1, said multifunctional acrylate monomer being present in said ink at level of between about 20 to about 60% by weight.

3. The digital ink according to claim 1, said multifunctional acrylate monomer being selected from the group consisting of 1,6-hexanediol dimethacrylate, neopentyl glycol diacrylate, tripropylene glycol diacrylate, ethoxylated trimethylolpropane triacrylate, trimethylolpropane triacrylate, 2-(2-ethoxyethoxy) ethyl acrylate, and combinations thereof.

4. The digital ink according to claim 1, said multifunctional acrylate monomer having a molecular weight of between about 100 g/mole to about 600 g/mole.

5. The digital ink according to claim 1, said monofunctional acrylate monomer being present in said ink at a level of between about 1 to about 20% by weight.

6. The digital ink according to claim 1, said monofunctional acrylate monomer being selected from the group consisting of methyl (meth)acrylate, ethyl (meth)acrylate, butyl (meth)acrylate, 2-phenoxyethyl acrylate, isobornyl acrylate, and combinations thereof.

7. The digital ink according to claim 1, said monofunctional acrylate monomer having a molecular weight of between about 100 g/mole to about 600 g/mole.

8. The digital ink according to claim 1, said polymer resin being present in said ink at a level of between about 1 to about 15% by weight.

9. The digital ink according to claim 1, said polymer resin being selected from the group consisting of polyethyl (meth)acrylate, polymethyl (meth)acrylate, polybutyl (meth)acrylate, and combinations and copolymers thereof.

10. The digital ink according to claim 1, said polymer resin having a molecular weight of between about 2500 g/mole to about 25,000 g/mole.

11. The digital ink according to claim 1, said oligomer being present in said ink at a level of between about 10 to about 30% by weight.

12. The digital ink according to claim 1, said oligomer having a molecular weight of at least about 10,000 g/mole.

13. The digital ink according to claim 1, said ink having a viscosity of between about 2 to about 50 cp at 35° C.

14. The digital ink according to claim 1, said ink being essentially solvent-free.

15. The digital ink according to claim 1, said ink not including a plasticizer.

16. The digital ink according to claim 1, wherein said ink further comprises at least one additional component selected from the group consisting of an initiator, a wetting agent, a rheology modifier, a stabilizer, and a pigment.

17. A method of printing an image on to a substrate comprising:
providing a substrate comprising a synthetic resin material; and
printing said image on said substrate using an inkjet printer and a digital ink, said digital ink comprising a multifunctional acrylate monomer, a monofunctional acrylate monomer, a polymer resin, and an oligomers.

18. The method according to claim 17, said substrate synthetic resin material being selected from the group consisting of polyvinyls, polyurethanes, polyolefins, polybutadienes, and combinations thereof.

19. The method according to claim 18, wherein said polyolefin is selected from the group consisting of linear low-density polyethylene, high-density polyethylene, low-density polyethylene, polypropylene, ethylene-propylene-(diene) copolymers and terpolymers, and combinations thereof.

20. The method according to claim 17, wherein said substrate is a pliable synthetic resin film.

21. The method according to claim 17, wherein said method further comprises causing said ink to cure on said substrate.

22. The method according to claim 21, wherein said substrate having said image printed thereon is exposed to UV radiation.

23. The method according to claim 21, wherein said substrate having said image printed thereon is exposed to heat.

24. The method according to claim 17, said multifunctional acrylate monomer being present in said ink at level of between about 20 to about 60% by weight.

25. The method according to claim 17, said monofunctional acrylate monomer being present in said ink at a level of between about 1 to about 20% by weight.

26. The method according to claim 17, said polymer resin being present in said ink at a level of between about 1 to about 15% by weight.

27. The method according to claim 17, said oligomer having a molecular weight of at least about 10,000 g/mole.

28. The method according to claim 17, said ink having a viscosity of between about 2 to about 50 cp at 35° C.

29. The method according to claim 17, said image upon being immersed in water for 48 hours showing no visible signs of peeling, cracking, or otherwise separating from said substrate.

30. The method according to claim 17, said image upon being exposed to a temperature of −10° C. for 1 hour showing no visible signs of peeling, cracking, or otherwise separating from said substrate upon flexing of said substrate.

31. The method according to claim 17, said image and said substrate forming a banner.

32. The method according to claim 17, wherein said ink is applied to said substrate using a multiple head inkjet system.

33. The method according to claim 32, wherein said ink is dispensed from one inkjet head of said system and a catalyst is dispensed from an adjacent inkjet head of said system, said catalyst mixing with said ink in order to initiate and/or accelerate curing of said ink on said substrate.
